(19) United States
(12) Patent Application Publication
(10) Pub. No.: US 2008/0196349 A1
(43) Pub. Date: Aug. 21, 2008

(54) CONNECTED STRUCTURAL PANELS FOR BUILDINGS

(75) Inventor: Francisco Vera Gonzalez, Alcobendas Madrid (ES)

Correspondence Address: DARBY & DARBY P.C., P.O. BOX 770, Church Street Station, New York, NY, 10008-0770, US

(73) Assignee: Harley Resources, Inc., British Virgin Islands (GB)

(21) Appl. No.: 12/027,592

(22) Filed: Feb. 7, 2008

(30) Foreign Application Priority Data
Feb. 13, 2007 (ES) 200700383

(51) Int. Cl. E04C 3/04; E04B 1/19; E04C 2/38; E06B 1/04

(52) U.S. Cl. 52/653.1; 52/693; 52/794.1; 52/656.2

(57) ABSTRACT

The present invention relates to the design, development and implementation of a building system using connected structural panels to form walls, floor slabs, stairs and other minor elements in buildings; characterised in that it is made up of a frame defined by peripheral trusses, wherein each truss consists of a metal structure based on two parallel rods tangentially joined to a zigzag rod by the corresponding peaks and troughs thereof; a plurality of vertical trusses thus formed are distributed equidistantly or not at a predetermined distance, acting as structural elements, and a plurality of horizontal and/or diagonal transversal rods are fastened to both the front and back sides distributed equidistantly or not at a predetermined distance as reinforcement elements to stiffen the panel, the assembly defining a hollow three-dimensional box; a tightened metal framework is joined to both the front and back sides as a means of support for the mortar that is applied to the front and back sides as a covering to form the wall.

This application claims the benefit of Spanish Application No. 200700383, filed Feb. 13, 2007, the entire disclosure of which is incorporated by reference.

### FIELD OF THE INVENTION

The present invention relates to the construction sector, in particular to the structural elements used in a prefabricated building system; more specifically it relates to the design, development and implementation of a building system using connected structural panels to form walls, stairs and other minor elements in buildings.

### BACKGROUND OF THE INVENTION

The traditional building method that is currently used is always based on the use of different types, shapes and sizes of bricks or lightweight concrete blocks in different thicknesses and sizes.

This building method has numerous disadvantages, which include:

Even if pallets are used, blocks and bricks are not simple to handle on the building site. They may be handled manually or using specialised machinery, which requires excessive labour and increases the cost.

They are fragile building elements, so their use is very wasteful. The process involved in finishing a wall is slow, regardless of whether plaster or cement mortar is used, as it is necessary to wait several days before it can be worked on again.

To put in plumbing, electricity, heating, telephone and sanitation installations, it has traditionally been necessary to make holes in the walls. This weakens them, it produces a lot of rubble, and it is necessary to cover the hole, which is slow and can lead to the appearance of cracks in the finished wall.

The final appearance of a brick or concrete block wall is not that of a finished wall, except in the case of those intended as facing brick, meaning that it is necessary to render it with cement mortar or to plaster it.

Bricks and concrete blocks are lightweight elements in themselves, but the finished wall multiplies their initial weight by several times. This must therefore be taken into account when calculating the weight of the structure.

In a traditional construction, concrete blocks and bricks are not used for load-bearing walls, they are normally dividing walls, so it is necessary to build a horizontal and vertical structure that supports the building.

Clay or cement posts require steel reinforcement when designed to form a load-bearing wall.

The cost of labour is high and it is in increasingly short supply.

The high demand for housing cannot be met by conventional building methods.

Severe weather conditions limit the time of year when building work can be carried out using conventional systems.

The present invention was developed as a response to all these drawbacks, disadvantages and problems resulting from traditional or conventional building systems, offering great advantages in terms of functionality, economy, more minor structural aspects, greater manoeuvrability, greater resistance to different loads, greater durability, a better appearance, etc.

### OBJECTIVES OF THE INVENTION

The main objective of the present invention is to provide connected structural panels for buildings, which are self-supporting and prefabricated to build walls, floor slabs, stairs, etc. of buildings and which can be covered with cement mortar and connected together by vertical and horizontal “shear keys”, monolithically forming the supporting structure of the building.

Another objective of the invention is to provide connected structural panels for buildings, which also makes it possible to divide the construction in a logical way according to its functional and architectural divisions, facilitating the joints between elements, installations and fittings.

A further objective of the invention is to provide said connected structural panels for buildings, which also, when used to make walls of buildings, essentially resist forces on their plane due to vertical or lateral loads; in their use as slabs they resist normal forces to their plane due to vertical loads and forces on their plane, acting as rigid diaphragms, in the presence of lateral loads.

Another objective of the invention is to provide said connected structural panels for buildings, which can also resist vertical loads, due to the small spans in buildings of social interest, and support lateral loads, due to the density of walls in both directions.

Another of the objectives of the invention is to provide said connected structural panels for buildings, which are also manageable, lightweight and do not require any particular manipulation; and which at the same time require very little labour for transport and installation.

Another of the objectives of the invention is to provide said connected structural panels for buildings, which also make it possible to build constructions with walls and floors quickly and precisely.

A further objective of the invention is to provide said connected structural panels for buildings, which, once installed, also make it possible to put in electricity, plumbing, telephone, heating and sanitation installations, which can be embedded in the structural element without having to make any type of hole, without producing rubble and without weakening the walls.

Yet another objective of the invention is to provide said connected structural panels for buildings, which also make it possible to build partition walls in houses, air chamber linings, partition walls in houses and stairwells; non-load-bearing facade enclosures and stair slabs; and facade and interior load-bearing walls and floors.

A further objective of the invention is to provide said connected structural panels for buildings, where the walls made from them are also much lighter than those made from simple plastered bricks or concrete blocks, which results in a significant saving in the structure of high-rise buildings.

Other objectives and advantages of the present invention may become apparent from studying the following description and the non-limiting drawings that accompany it solely for illustrative purposes.

### BRIEF DESCRIPTION OF THE INVENTION

Basically, the connected structural panels for buildings consist of a frame defined by peripheral trusses, wherein each truss consists of a metal structure based on two parallel rods tangentially joined to a zigzag rod by the corresponding peaks and troughs thereof; a plurality of vertical trusses thus formed are distributed equidistantly or not at a predetermined distance, acting as structural elements, and a plurality of horizontal and/or diagonal transversal rods are fastened to both the front and back sides distributed equidistantly or not at a predetermined distance as reinforcement elements to stiffen the panel, the assembly defining a hollow three-dimensional box; a metal framework made from cold-rolled sheet steel, galvanised or ungalvanised, die-cast and expanded, is joined to both the front and back sides as a means of support for the mortar that is applied to the front and back sides as a covering to form the wall.

All the joints of these metal elements are created by spot welding in a workshop, using an automatic process.

The rods of the panel can be of variable diameters depending on their structural function; and their separation varies from 50 mm to 200 mm depending on the use for which each element is designed, whether for walls, façades, stairs, load-bearing walls or floors.

The metal framework is made from cold-rolled sheet steel with thicknesses of 0.3 mm, 0.4 mm and 0.5 mm, galvanised or ungalvaised, die-cast and expanded, and it can comprise intermediate reinforcement ribs; adjusted to a width of 600 mm and a variable length according to the height of the structural panel. Said metal framework comprises a coating of an anticorrosive material.

The structural panel preferably uses a thickness of 0.3 mm for the metal framework, as the purpose of the metal framework is only to act as a support for the cement mortar that is applied. This metal framework can have a paper backing adhered to it (depending on the panel in question), which prevents the air chamber from filling with finishing mortar and causing undesired thermal bridges. In one of the modalities said metal framework is cut with a width of 560 mm for each face of the 600 mm structural module and it is welded to the inner face.

In the case of door and window openings, the metal framework is also fixed to the edges of the panels to receive the mortar as a covering in these areas to create the surface that receives the window and door frames.

Moreover, depending on the wall in question, load-bearing façades, separations between houses and stairwells, the inner chamber may, if necessary, be filled with some type of insulation, formaldehyde foam, rigid polyurethane foam, or glass wool, according to the thickness of the chamber and the type of insulation that is required, whether heat or sound and heat, which is always applicable in different thicknesses and densities.

The panel can be manufactured in a great variety of dimensions according to the needs of the building project and according to the use or purpose of each panel, whether for walls, façades, stairs, load-bearing walls or floors.

The vertical panel, whether for outside or inside walls or for divisions between houses, it is mounted vertically on the framework of strip footing, and once levelled, it is fastened thereto by said projecting ends of the vertical rods of the trusses.

To create walls, it is possible to produce a panel that covers the whole surface of a wall or several panels can be formed to complete that surface, joining adjacent panels either by 0.8 mm thick galvanised wire or by a shear key consisting of a rounded U-shaped section, which are hooked around the adjacent parallel vertical rods of the trusses of adjacent panels on the front or back, the ends of which are bent around the corresponding adjacent parallel vertical rods of the same trusses but on the opposite side, thus forming the wall in question, then fitting the structural steel of the structural shear key.

Once the floor has been fastened and the wall has been formed, the layout of the installations is finalised and they are fitted inside the wall, cutting the metal framework to insert pipes and secure (electrical) mechanisms. The pipes of the electricity, plumbing, sanitation, telephone installations, etc. can be incorporated into the panels and fastened by some means at the factory as the panel is being mounted or on site when they are installed.

Once the installations have been put in, the two sides of the structural element are covered with cement mortar (for external façades and structural walls inside, separations between houses and stairwells) or with plaster mortar (for non-structural partition walls, linings), depending on its function in the building.

Panels matching the necessary dimensions for the building in question can be created from a 60 cm×h (height)×t (thickness) module in accordance with international building standards.

Using a modular system for the structural panels as a basis for standardising building elements in a housing project of social interest is a fundamental condition for industrialising production.

The configuration of the panels makes it possible to coordinate the dimensions of all the building elements, materials and installations, referring to a basic configuration called a module, making the installers' job as simple as possible; thus, production will be more economical and building work will be faster and easier.

The dimensions of the structural panel are large enough for a suitable correlation to be established between the modular dimensions of the elements and the modular spaces of a project. What is more, the structural panel is small enough for its multiples to correspond to all the dimensions that must be provided for the different elements in the industrial range, and to present a suitable growth unit from one modular dimension to the next, so that modifications can be kept to a minimum.

The panel can also be used to form floor slabs.

The prefabricated structures made from the structural panel are thick building elements, made from structural steel that is sufficiently rigid to be transported and self-supporting for assembly on site, ready to receive the structural mortar on site to form a cement wall that is resistant to the vertical loads of the building and the horizontal loads of a seismic event.

On site, the panels form the wall by means of connections using “shear keys”, as mentioned above, which also act as vertical stiffeners.

The walls thus constructed are connected to the foundation beam and the floor slab that is made using the same system.

The inner and outer sides, respectively, of panels in buildings to be used as housing, offices, schools, hospitals, etc. are finished and ready to receive a structural mortar. Their geometry has two main dimensions, one being the floor height according to the project, which includes the door and window openings, and the other being the thickness determined by the respective structural design.

The system includes the prefabrication of all the panels for all the inside and outside walls, floor slabs, stairs, etc., and variants are possible, particularly in the case of façades where particular importance is to be given to the design of openings provided for windows, doors, etc.

The structure thus formed ensures continuity and works as a monolithic assembly against the actions of gravity and earthquakes.

The behaviour of these panel-based structures in the event of seismic actions is within the elastic range, with small deformations.

In buildings, the structural panel system described herein is suitable for three-dimensional arrangements of modular panels that are efficient in resisting vertical loads, due to the small spans in buildings of social interest, and in supporting lateral loads, due to the density of walls in both directions.

Walls made from the structural panels are much lighter than those made from simple plastered bricks or concrete blocks. One m² of wall made from the structural panel weighs 100 kg/m² (plastered) finished with cement mortar, whereas one m² of a plastered hollow brick double-layer partition weighs 160 kg/m².

The structural panels as described herein can have a variety of uses, such as:

a) for building load-bearing walls; in load-bearing walls, the main structure undergoes slight variations compared to structure of the rest of the non-structural walls, according to the respective design.

Their standard dimension is 500 mm wide by a variable height and its thickness is variable, depending on the design of the project, and they are connected by shear keys.

For example, for a one-storey house, each 600 mm wide panel forms a strong 600 mm×240 mm vertical element once covered, made from two lateral trusses manufactured with round bars and diagonal round bars (fulfilling the function of abutments of the framework).

A shear key can be established between adjacent walls on each side of the 600 mm wide modules, the diagonal rods will project alternately from the 80 mm edge truss. These links of the rods will be horizontally attached to the adjacent panel by 0.8 mm thick galvanised wire, leaving a 100 mm separation between modules.

It is necessary to anchor these load-bearing walls to the foundations and attach them thereto, creating a joint that is capable of resisting the compression loads transmitted by the upper floor. To do this, every 600 mm, i.e. where the strong support is formed, the two lateral round steel bars that form the trusses will be prolonged by 15 to 30 cm and their ends will be bent to form an anchoring clamp. The framework will therefore be anchored to the foundations and will be capable of transmitting the compression stresses to which the load-bearing wall is subjected.

Once the module is fastened to the foundations and the wall has been formed, its two sides are covered with 150 kg/cm² cement mortar and the support (foundations) is covered with a 210 kg/cm² strength concrete. In order to be able to apply the concrete a board must be placed on each outer face, attached to the lateral trusses with wire and nails driven into it, then after 7 days the wires can be cut and the formwork removed.

Should better sound and heat insulation be required than that achieved by the air chamber of the structural panel, sheets of an insulating material of the necessary characteristics and thicknesses may be inserted before covering the wall.

b) for floors, using the designed framework in floor slabs with spans of up to 4.00 metres, it is identical to that used in load-bearing walls, except that it is laid horizontally, and what was the strong support in walls is the joist that is made “in situ” or partially prefabricated in floors. In turn, the two sides of the structure are finished in a different way; the upper side is finished with the obligatory 50 mm thick compression layer and the lower side is finished with 20 mm of projected cement mortar.

It will be necessary to use the round steel bars as negatives in the compression layer and above the joists, the diameter of said round bars depending on the span of the floor, according to a respective structural design. A steel mesh must also be laid for temperatures and refractions. A structural design must be prepared for each building project.

c) as complementary elements, where the building work requires the use of main structures that are designed to fulfil the function of lintels and window sills. It is known that the module used in the main structure can have a height of 2600 mm, of which a height of 80 mm is reserved for the floor finish and for putting in the horizontal installations. 20 mm must also be subtracted for the finish of the lower side of the element that forms the floor.

Therefore, we have a free height of 2500 mm, which complies with the specifications of all types of housing.

This free height, where a window can be positioned, is divided into: Lintel: 400 mm high; Window opening: 1200 mm high; Windowsill: 1000 mm high (920 mm of free height).

Therefore, the lintel is made from a main structure that is 600 mm wide by 400 mm high, with the same characteristics as the main framework used in the outside walls, whether load-bearing or not, only the upper and lower ends of the trusses varying. Thus, the 6 or 8 mm round bars at the end of these project from the end of the truss by 150 mm, to be embedded in the lateral elements of the wall, serving as load-bearing supports.

The windowsills are made with a main structure that is 600 mm wide by 1000 mm high, leaving 920 mm free once the floor is finished and the horizontal installations have been put in. The dimensions are variable, the dimensions of the panel being adapted according to the needs of the project.

To make the window openings, the dimensions can be altered according to the needs of the project, both in width and height.

The main framework is made up of round steel bars of a variable diameter according to the element in question and the height thereof.

This type of round bar is normally used in the frameworks of joists made “in situ” for floors with larger spans than those used with this module.

It may also have a paper backing adhered to it, depending on its situation; it will normally have this for partitions and inside dividing walls in houses.

The mortars used are those normally sold, which are specially manufactured to be projected.

Alternatively, a type of plaster with better sound and heat insulation can be used, e.g. Perliyeso or Perlinar, which is made from a mixture of perlite and plaster, with better heat and sound insulation and fireproof properties than normal plaster.

For a better understanding of the characteristics of the invention a set of illustrative but non-limiting drawings accompany the present description as an integral part thereof, which are described below.

### BRIEF DESCRIPTION OF THE DRAWINGS

FIG. 1 shows a side view of one of the trusses that form the structural panel for buildings.

FIG. 1a shows a side view of a portion of a truss of the panel according to the present invention.

FIG. 2 shows a conventional perspective view of a standard structural panel for buildings according to the present invention.

FIG. 2a shows a conventional perspective view of another modality of a panel for buildings.

FIGS. 2b and 2c show details “A” and “B”, as indicated in FIG. 2, of the upper and lower ends, respectively, of the standard structural panel for buildings according to the present invention.

FIG. 3 is a conventional perspective view of a structural panel with a door opening, according to the present invention.

FIG. 4 is a conventional perspective view of a structural panel with a window opening, according to the present invention.

FIG. 5 shows a conventional perspective view of a plurality of panels joined together to form a house structure with a gable roof, with structural panels according to the present invention.

FIG. 6 shows a conventional perspective view of a structural panel for buildings showing the mortar that will be applied to both sides to form a wall.

FIG. 7 show a schematic diagram of a building made from the panels according to the present invention.

For a better understanding of the invention, a detailed description will now follow of some of the modalities thereof, as shown in the non-limiting drawings that are attached to the present description for illustrative purposes.

### DETAILED DESCRIPTION OF THE INVENTION

The characteristic details of the connected structural panels for buildings are clearly shown in the following description and in the illustrative drawings that are attached, which serve as reference marks to indicate the parts that are being referred to.

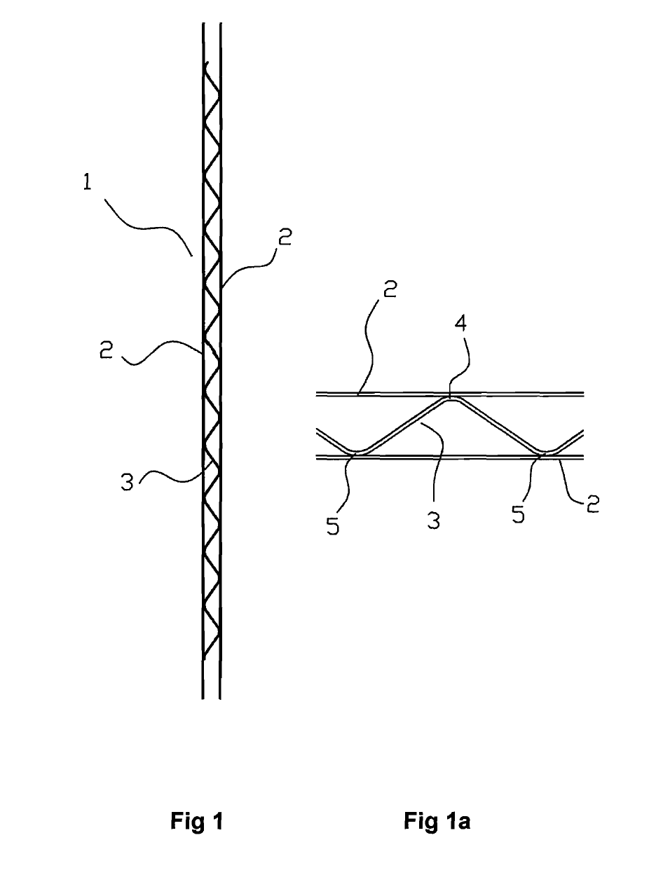

With reference to FIG. 1, it shows a side view of one of the trusses that form the structural panel for buildings. In said figure, the trusses 1 consist of a metal structure based on two parallel rods 2 that are tangentially joined to a zigzag rod 3 by its corresponding peaks and troughs.

With reference to FIG. 1a, it shows a side view of a portion of a truss 1 of the panel according to the present invention. In said figure, it can be observed that the zigzag rod 3 is tangentially joined to both the parallel rods 2, where the peaks 4 and troughs 5 are fixed to the corresponding parallel rod 2. The peaks and troughs 4 and 5 of the zigzag rod 2 have a longitudinal section that ensures a tangential joint with the parallel rods 2 along a considerable longitudinal section, making the structure stronger.

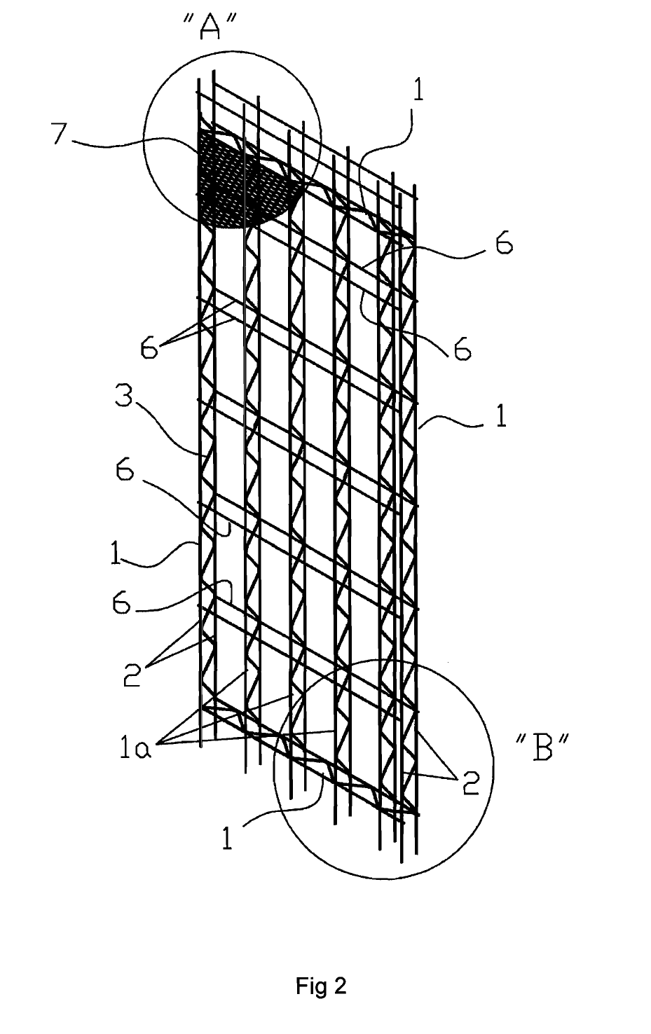

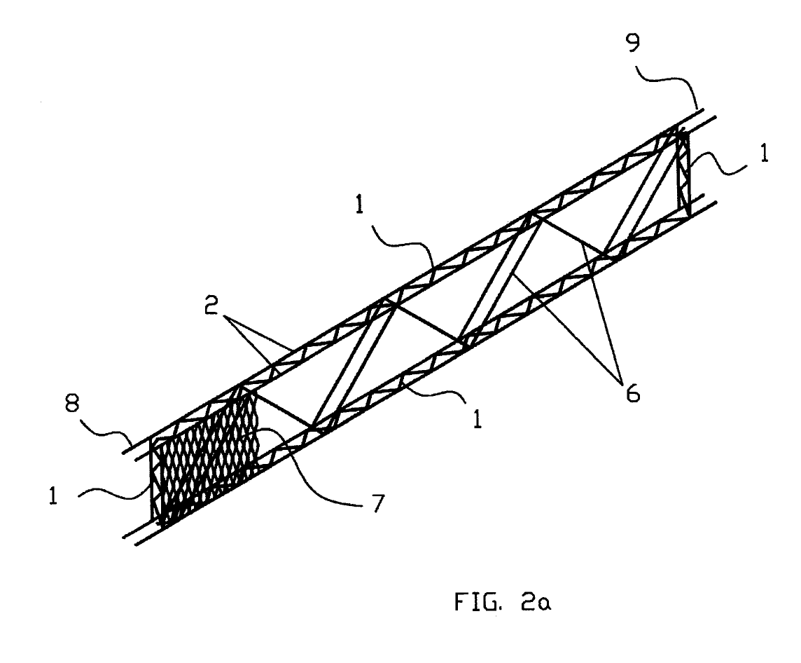

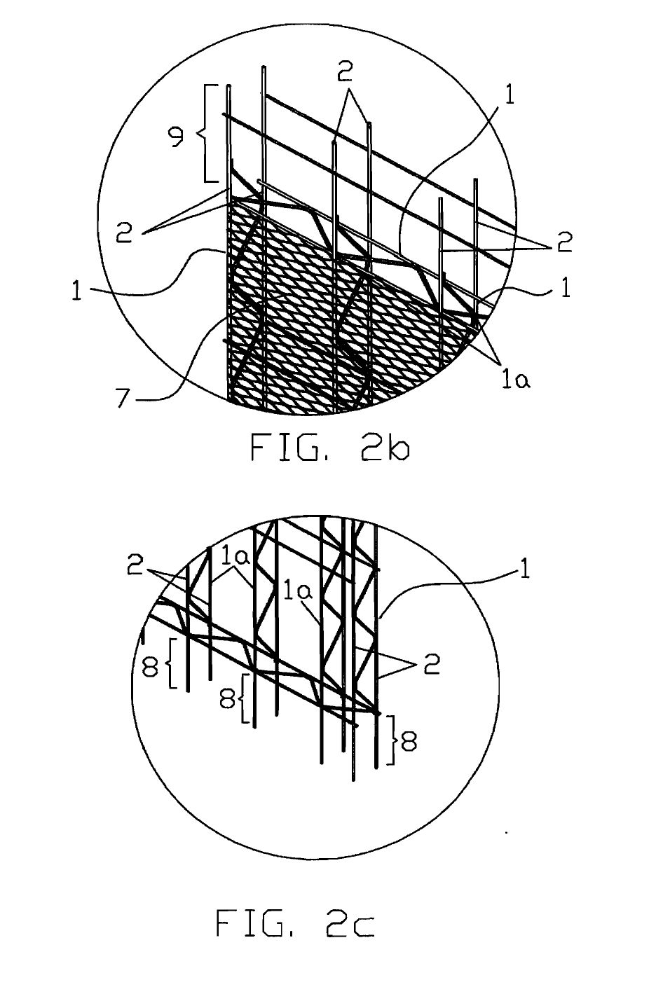

With reference to FIG. 2, it shows a conventional perspective view of a standard structural panel for buildings according to the present invention. In said figure, the panel is made up of a frame defined by peripheral trusses 1 like those described in FIGS. 1 and 2; a plurality of vertical trusses 1a thus formed are distributed equidistantly or not within the frame at a predetermined distance, which act as structural elements, and a plurality of horizontal and/or diagonal transversal rods 6 are fastened to both the front and back sides distributed equidistantly or not at a predetermined distance as reinforcement elements to stiffen the panel, the assembly defining a hollow three-dimensional box; a metal framework 7 made from cold-rolled sheet steel, galvanised or ungalvanised, die-cast and expanded, is joined to both the front and back outer sides, as a means of support for the mortar (not shown) that is applied to the front and back sides as a covering to form the wall.

Said metal framework 7 is tightened to prevent deformations and it is welded to both the parallel rods 2 of each peripheral truss 1 and the plurality of vertical trusses 1a and to the transversal rods 6 that reinforce and stiffen the panel.

With reference to FIG. 2a, it shows a conventional perspective view of another modality of a panel for buildings. In said figure, the panel is made up of a frame defined by peripheral trusses 1 like those described in FIGS. 1 and 2; said peripheral trusses 1 act as structural elements and a plurality of transversal rods 6, which in this case are diagonal, are fastened to both the front and back sides distributed equidistantly or not at a predetermined distance as reinforcement elements to stiffen the panel, the assembly defining a hollow three-dimensional box; a metal framework 7 made from cold-rolled sheet steel, galvanised or ungalvanised, die-cast and expanded, is joined to both the front and back outer sides, as a means of support for the mortar (not shown) that is applied to the front and back sides as a covering to form the wall. The panel may be wider and may comprise several vertical trusses 1 within the frame. The panel shows the lower 8 and upper 9 extensions of the parallel rods 2 that form each vertical truss, as a means of fastening and securing the panel to the foundations and for anchoring the panel to the roof plate, or for preparing the panel that acts as formwork for mounting the roof plate.

With reference to FIGS. 2b and 2c, they show details “A” and “B” as indicated in FIG. 2, of the upper and lower ends, respectively, of the standard structural panel for buildings according to the present invention. In said figures the lower and upper ends of the vertical parallel rods 2 that make up each truss 1 and 1a project beyond the limit of the corresponding lower and upper sides of the panel, the projecting lower ends 8 of each truss 1 and 1a (see FIG. 2b) projecting from the panel to be fastened and secured to the foundations (not shown). The projecting upper ends 9 of the parallel rods 2 of each truss 1 and 1a (see FIG. 2a) project upward from the panel to anchor the panel to the roof plate, or to prepare the panel that acts as formwork for mounting the roof plate.

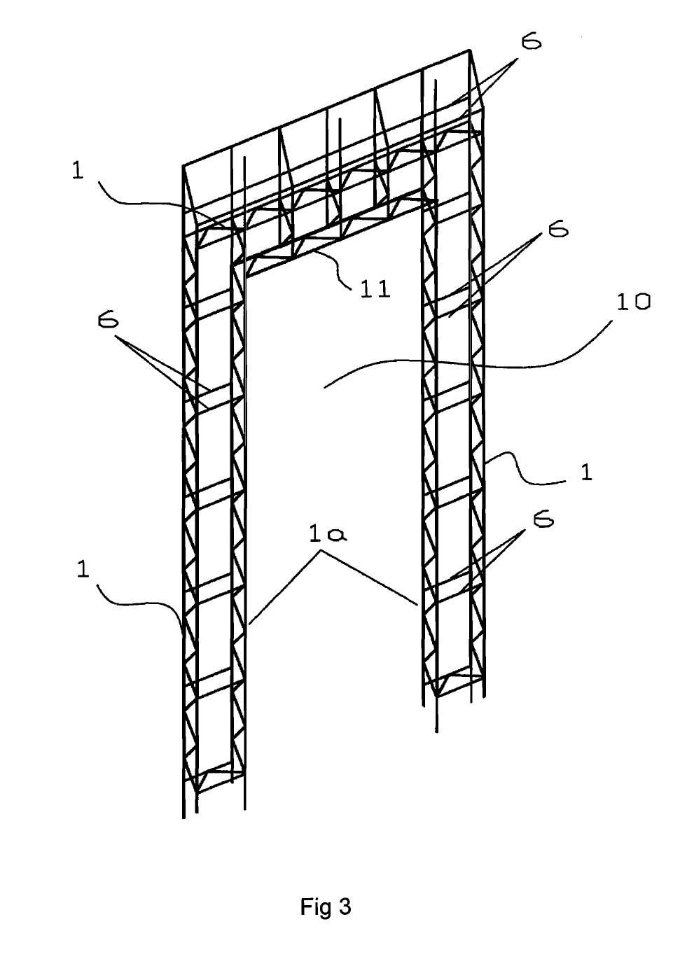

With reference to FIG. 3, it shows a conventional perspective view of a structural panel with a door opening, according to the present invention. In said figure, the structural panel is made up of peripheral trusses 1 and comprises at least another two trusses 1a that define the limits of the door opening 10 and a horizontal upper truss 11 that defines the upper limit of the door opening 10; a plurality of transversal rods 6 joined to both the front and back sides, distributed equidistantly or not at a predetermined distance as reinforcement elements to stiffen the panel.

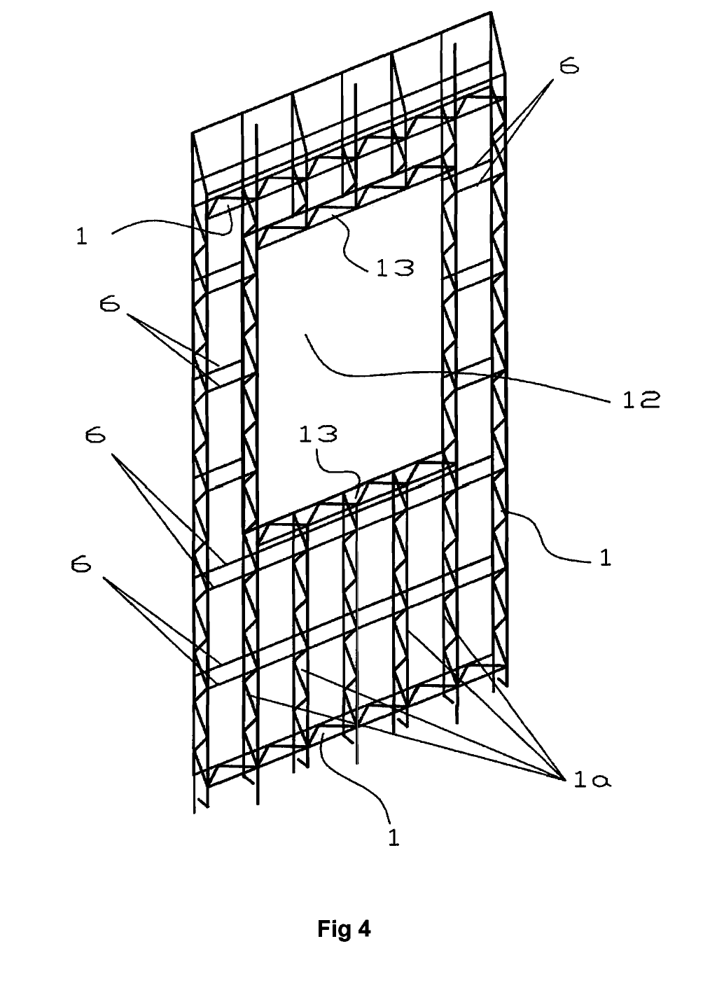

With reference to FIG. 4, it shows a conventional perspective view of a structural panel with a window opening, according to the present invention. In said figure, the structural panel is made up of peripheral trusses 1 and other intermediate trusses 1a of the frame, some of which are shorter to define the window opening 12, two vertical trusses 1a and two horizontal trusses 13, one at the top and one at the bottom, delimiting said window opening 12; a plurality of transversal rods 6 joined to both the front and back sides of the panel, distributed equidistantly or not at a predetermined distance as reinforcements elements to stiffen the panel.

In both the panels shown in FIGS. 3 and 4, the metal framework 7 is integrated into both the front and back sides of the panels (framework 7 not shown so that the structure of the panel can be seen better).

In both FIGS. 3 and 4, the metal framework 7 (not shown so that the structure of panel can be seen better) is also fastened to the edges around the door 10 and window 12 openings to receive the mortar and create a covering in those areas to create the surface that receives the window and door frames.

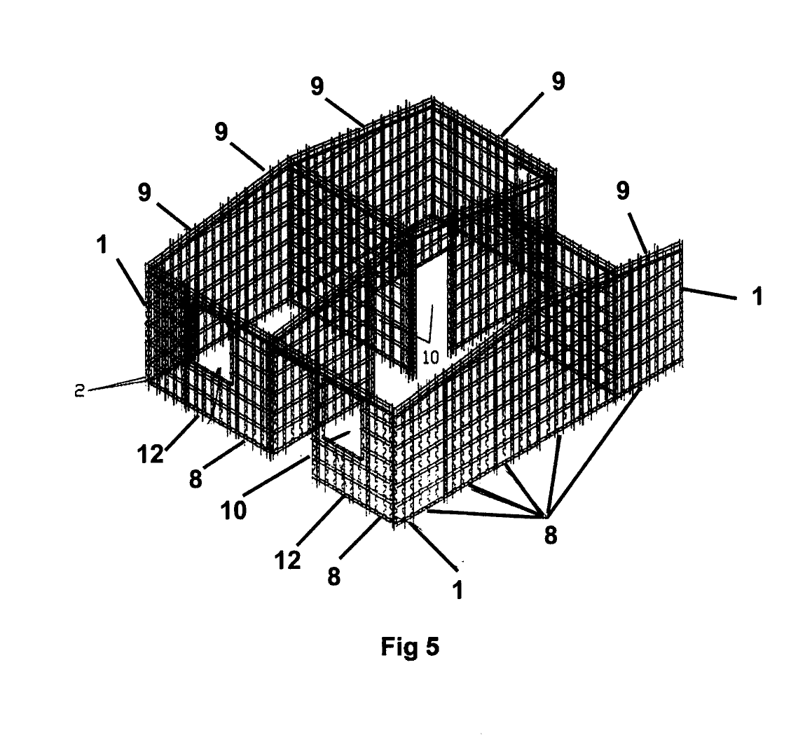

With reference to FIG. 5, a plurality of panels of the same and different configurations, depending on the needs of the project, are joined together by shear keys (not shown) to form a house structure with a gable roof, using structural panels according to the present invention, which define the different areas of the house, with its door and window openings 10 and 12. The metal framework is not shown so that the structure of the panel can be seen better, which receives the mortar to create a covering and hence form the walls of the house. All the panels are anchored by the projecting lower ends 8 of each truss 1 and 1a, which project from the panel to be fastened and secured to the foundations (not shown). The projecting upper ends 9 of the parallel rods 2 of each truss 1 and 1a project upward from the panel to anchor the panel to the roof plate, or to prepare the panel that acts as formwork for mounting the roof plate. The same numerical references are used in FIG. 5 as in the previous figures.

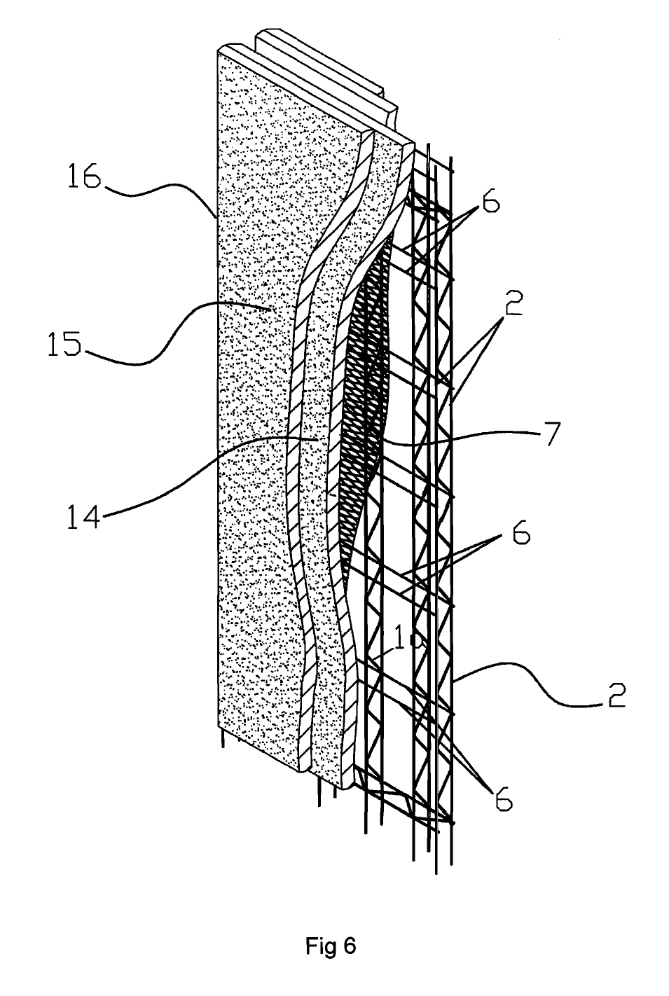

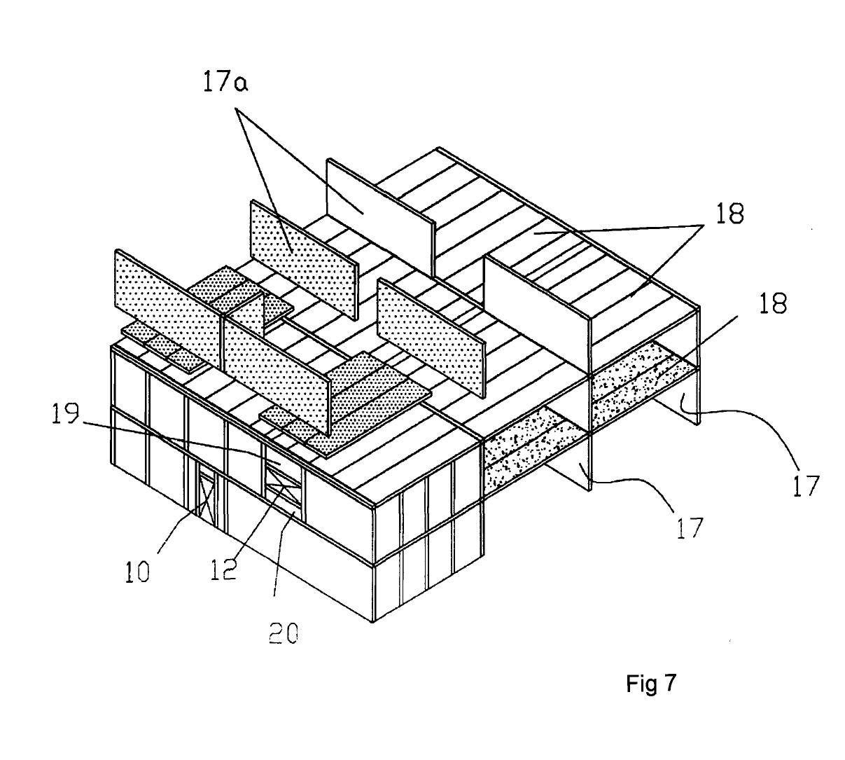

With reference to FIG. 6, in a structural panel for buildings, the application of a first layer 14 of mortar can be observed and a second thickening layer 15 is applied over the first, the mortar being applied to both sides of the panel to form a wall 16, the tightened metal framework 7 that is fastened to both sides of the panel to the parallel rods 2 of both the peripheral 1 and intermediate trusses 1a and to the transversal rods 6, acting as a support for the mortar.

The minimum thickness to be used for the cement mortar covering is approximately 25 mm, projected using a machine or manually in two continuous layers 14 and 15 and in an amount that is capable of creating a minimum strength of 100 kg/cm². Prepared or stabilised mortars can be used, with a predetermined mixture to ensure its adherence to the metal framework and to prevent it from entering the panel.

For the mortar finish, the surface must be levelled with aluminium straight edges in order to achieve a perfectly flat surface of the finished wall.

The invention has been sufficiently described for a person skilled in the art to reproduce and obtain the results mentioned herein. However, any person skilled in the art that uses the present invention may be able to make modifications that are not described in the present application and where the subject matter claimed in the following claims is required for the application of these modifications to the particular structure or to the manufacturing process thereof, said structures must lie within the scope of the invention.

1. Connected structural panels for buildings comprising: a frame defined by peripheral trusses, wherein each truss consists of a metal structure based on two parallel rods tangentially joined to a zigzag rod; a plurality of vertical trusses thus formed distributed at a distance predetermined equidistantly or not act as structural elements; a plurality of horizontal and/or diagonal transversal rods are fastened to both front and back sides at a predetermined distance distributed equidistantly or not, as reinforcement elements to stiffen the panel, wherein an assembly of the connected structural panels defines a hollow three-dimensional box; a tightened metal framework is joined to both the front and back sides as a means of support for mortar that is applied to the front and back sides as a covering to form a wall.

2. Connected structural panels for buildings, according to claim 1, wherein all joints between the parallel rods with the zigzag rod and the transversal rods, as well as joints of said metal framework, are created by spot welding using an automatic process.

3. Connected structural panels for buildings, according to claim 1, wherein said metal framework is made from cold-rolled sheet steel with thicknesses of 0.3 mm, 0.4 mm and 0.5 mm, galvanised or ungalvanised, die-cast and expanded, and it can comprise intermediate reinforcement ribs; adjusted to a width of 600 mm and a variable length according to the height of the structural panel.

4. Connected structural panels for buildings, according to claim 1, wherein said metal framework can have a paper backing adhered to it, which prevents an air chamber of the panels from filling with finishing mortar and causing undesired thermal bridges.

5. Connected structural panels for buildings, according to claim 4, wherein the inner chamber of the panels generates a volume of air as insulation, once the sides have been covered with the mortar.

6. Connected structural panels for buildings, according to claim 4, wherein the inner chamber of the panels is filled with an insulating material selected from: formaldehyde foam, rigid polyurethane foam, or glass wool, according to the thickness of the chamber and the type of insulation that is required, whether heat or sound and heat, which is always applicable in different thicknesses and densities.

7. Connected structural panels for buildings, according to claim 1, wherein adjacent panels are joined to form walls either by galvanised wire of a predetermined thickness or by a shear key, which secure the parallel rods of adjacent peripheral trusses, distributed at points along the longitudinal section of said parallel rods.

8. Connected structural panels for buildings, according to claim 7, wherein said shear keys consist of a rounded U-shaped section that is hooked around adjacent parallel vertical rods of the trusses of adjacent panels on the front or back, the ends of which are bent around the corresponding adjacent parallel vertical rods of the same trusses but on the opposite side.

9. Connected structural panels for buildings, according to claim 1, wherein said transversal rods are fastened diagonally, projecting alternately from the edge of the frame to bend and secure an adjacent panel.

10. Connected structural panels for buildings, according to claim 1, wherein lower and upper ends of parallel vertical rods that make up each truss project beyond a limit of the corresponding lower and upper sides of the panel, the projecting lower ends of each truss are bent to form a clamp that can be fastened and secured to the foundations to anchor the panels, whilst the projecting upper ends are bent to anchor the panel to the roof plate, or to prepare the panel that acts as formwork for mounting the roof plate.

11. Connected structural panels for buildings, according to claim 1, wherein they comprise door and window openings.

12. Connected structural panels for buildings, according to claim 11, wherein edges of the door and window openings are delimited by trusses, to which a section of metal framework is fastened to receive the mortar in those areas and create the surface that receives the window and door frames.

13. Connected structural panels for buildings, according to claim 1, wherein said metal framework comprises a coating of an anticorrosive material.
